(19) United States
(12) Patent Application Publication
(10) Pub. No.: US 2006/0194483 A1
(43) Pub. Date: Aug. 31, 2006

(54) Folding box

(76) Inventor: Julian Escarpa Gil, Aldaia (Valencia) (ES)

Correspondence Address: KLAUBER & JACKSON, LLC, 4TH FLOOR, 411 HACKENSACK AVE., HACKENSACK, NJ, 07601, US

(21) Appl. No.: 11/412,486

(22) Filed: Apr. 27, 2006

Related U.S. Application Data
(63) Continuation of application No. PCT/ES04/00476, filed on Oct. 29, 2004.

(30) Foreign Application Priority Data
Oct. 31, 2003 (ES) U 200302479

(51) Int. Cl. H01R 13/11

(52) U.S. Cl. 439/852

(57) ABSTRACT

The invention relates to a plastic box of the type that comprises a heavy-duty base and four folding side walls which can be folded down onto the base. In addition, the side walls can be dismantled. The constituent parts of the box are connected using male elements which are solidly connected to the side walls and female elements which are disposed on the base. The inventive box is characterised in that it comprises a particular structure comprising male elements and female elements. The invention is further characterised in that the structure is equipped with air vents which enable the product contained in the box to be ventilated more effectively.

### RELATED APPLICATIONS

The present application is a Continuation of co-pending PCT application Ser. No. PCT/ES2004/000476, filed on Oct. 29, 2004 which in turn, claims priority from Spanish Utility Model Application Ser. No. U200302479, filed on Oct. 31, 2003. Applicants claim the benefits of 35 U.S.C. §120 as to the PCT application and priority under 35 U.S.C. §119 as to said Spanish application, and the entire disclosures of both applications are incorporated herein by reference in their entireties.

### OBJECT OF THE INVENTION

As expressed in the title of this specification, the present invention refers to a folding box of plastic material which is of the type of those that comprise a sturdy base and four folding side walls, in such a way that when the box is not used and essentially during transport, these four side walls fold over the bottom of the box in planes parallel to the base.

The side walls can be easily disassembled when required, such as for example when it is necessary to replace one by another one because one has become damaged or broken.

Starting from this premise, the object of the invention is a more solid and secure coupling system of the side walls.

Another object of the invention is to achieve more effective ventilation of the product contained inside the box thanks to the new structure having the largest number of ventilation holes that the side walls and bottom include.

### BACKGROUND OF THE INVENTION

Nowadays there are different types of boxes, among which it is worth pointing out those that are made of plastic material and of these boxes those that comprise a folding structure in order to reduce their volume when they are empty, especially during transport.

Among these types of boxes, the following documents are worth pointing out: WO-00/63084, BE-09600804, EP-0786412, DE-29501696, DE-3347367, US-4917255, EP-0921078, EP-1174354, ES-2009005 and U-9200772.

In turn, among these boxes, some in general have a rectangular base, to whose sides the folding side walls are removably coupled, in such a way that during use thereof, said walls are placed in vertical planes perpendicular to the bottom, whereas when the boxes are not being used, the side walls collapse inward in horizontal planes parallel to said rectangular base corresponding with the bottom of the box assembly.

For example, BE-09600804 consists of a plastic box, whose side walls (front ends and sides) are jointedly coupled on the side edges of the base, at the same time that the front ends and sides are connected by their adjacent vertical edges in a unfolded usage position.

During folding, the two front ends are arranged on a single bottom horizontal plane, whereas the sides are arranged on another top single plane above the front ends.

### DESCRIPTION OF THE INVENTION

The folding box that constitutes the object of the invention is defined by a rectangular base, whose side edges have in principle some female parts that are complemented with some male coupling parts that form part of the side walls in order to allow the assembly and disassembly thereof, as well as their collapsing for the folding and unfolding of said side walls.

For this purpose, the large side edges of the bottom are located on a lever higher than the smaller side edges and consequently, the female parts of both edges are also at different levels.

The female parts of the side edges of the base are characterized in that they comprise a center recess, an end recess and also an end hole opposite the anterior end recess.

The male parts are in turn characterized in that they comprise a center body, an end shaft that is complemented with the hole of the female part and an end projection that is complemented with the end recess of the female parts.

Another characteristic of the invention is that the combination of the male parts and female parts allow us to begin the coupling of the side walls with a specific angle smaller than 90°. This angle is formed between said walls and the plane of the base of the box and said 90° angle corresponds with the final position of the complete assembly of the box. Therefore, it is only possible to start to assemble or disassemble the side walls by positioning them with a specific angle with respect to the base of the box.

Hence, considering the larger side walls or sides, in the beginning of the assembly thereof, the shaft of the male part will be opposite the hole of the female part. In this position, the projection of the male part will be located in the recess of the female part. In this initial position, the center body of the male part will be located in the recess of the female part.

Starting from this initial position described of each side, moving forward in the assembly, this end will move parallel to the direction of the respective larger edge of the base, whereby, the shaft of the male part will be inserted in the hole of the female part, whereby, the center body as well as the end projection of the male part will face each other in correspondence with the recess of the female part.

In this new position of the side, said side will be able to collapse outward around the shafts and complementary holes until the side is located in the final position perpendicular to the base, in such a way that the sides as well as the larger edges of the base have some flat seats which will contact with each other in this final position. At the same time, the seats are interrupted by the male parts and female parts.

Once the sides are completely coupled in the female parts of the base, said sides will also be able to collapse inward in order to place them horizontally on the base in the folded position. The front ends will have also been previously folded.

In the coupled position of the sides, said sides cannot come loose, but rather it is only possible in the specific angular assembly position, since now the end projection of the male parts come up against the front surface of the recess where the cavity of the female part originates.

After assembling the sides, the front ends are then assembled by means of the male parts and female parts as in the case of the sides. Other anchoring elements located in the vertical adjacent edges of the sides and front ends also take part in the assembly. These anchoring elements comprise the blocking of the total unfolding of the box assembly and therefore, the complete assembly thereof. This blocking is achieved at the end of the collapsing of the front ends towards their final position perpendicular to the base.

Hence, the new anchoring parts basically comprise some projections that fit in open notches, in such a way that the projections have recesses at the end of these ramp inclined areas, which by elastic connection some bottom edges of the open notches fit in said recesses.

In the end collapsing section of the front ends, the inclined areas of the projections contact with and press against the bottom edges of the notches until the total unfolding of the front ends is achieved where these bottom edges will fit by elastic connection in the recesses of the projections of the front ends, just as it has been explained above.

Aside from the above-mentioned anchoring parts, there are some top gradations in the sides of the front ends that complementary come up against some top flaps of the ends of the sides.

The folding of the box is started by unblocking the front ends by collapsing them towards the inside pushing upward a little at the beginning in order to release the anchoring of said front ends.

Once the front ends have been completely collapsed and folded until they are placed in a coplanar position upon the bottom of the box, then the sides that will be placed upon the front ends in another coplanar plane are collapsed.

Another characteristic of the invention refers to the particular structure that has the largest number of ventilation holes of the box. These ventilation holes have an elongated shape with rounded ends and large arched center sections that make these ventilation holes narrow.

The box includes other circular ventilation holes.

Hereinafter to provide a better understanding of this specification and forming an integral part thereof, some figures wherein the object of the invention has been represented in an illustrative and non-restrictive manner are attached hereto.

### BRIEF DESCRIPTION OF THE DRAWINGS

FIG. 1 shows an exploded perspective view of the folding box of the invention.

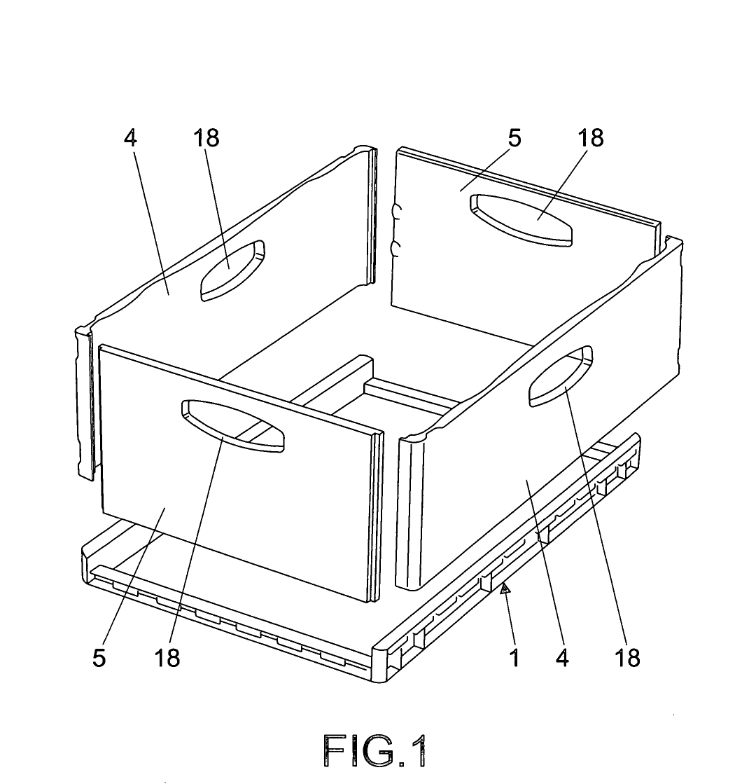

FIG. 2 shows a perspective view wherein the assembly system of the larger side walls or sides upon the bottom base of the box is essentially shown.

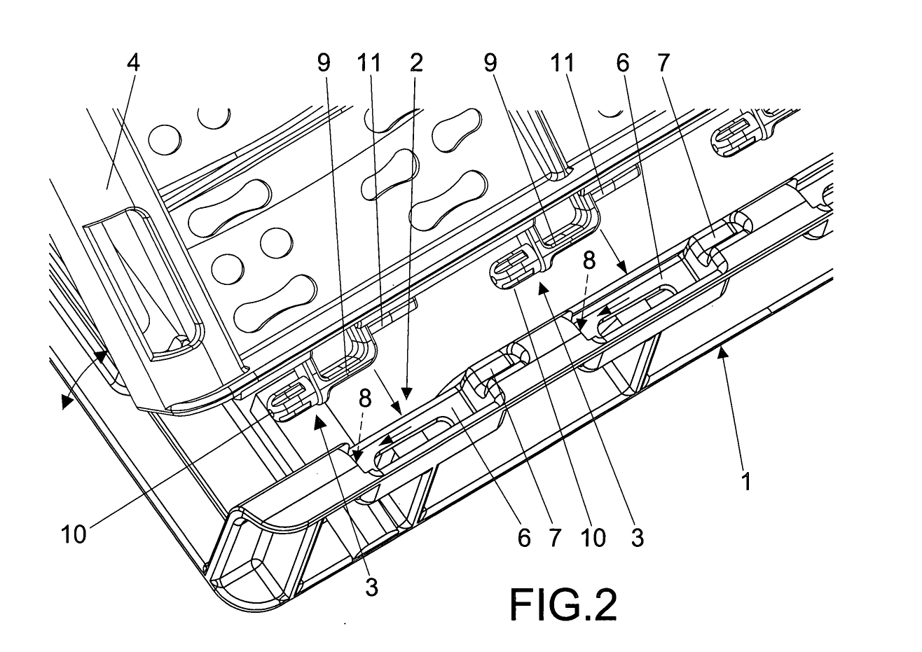

FIG. 3 shows a perspective view wherein one can see the assembly of the front ends that are connected with the sides by their adjacent vertical edges.

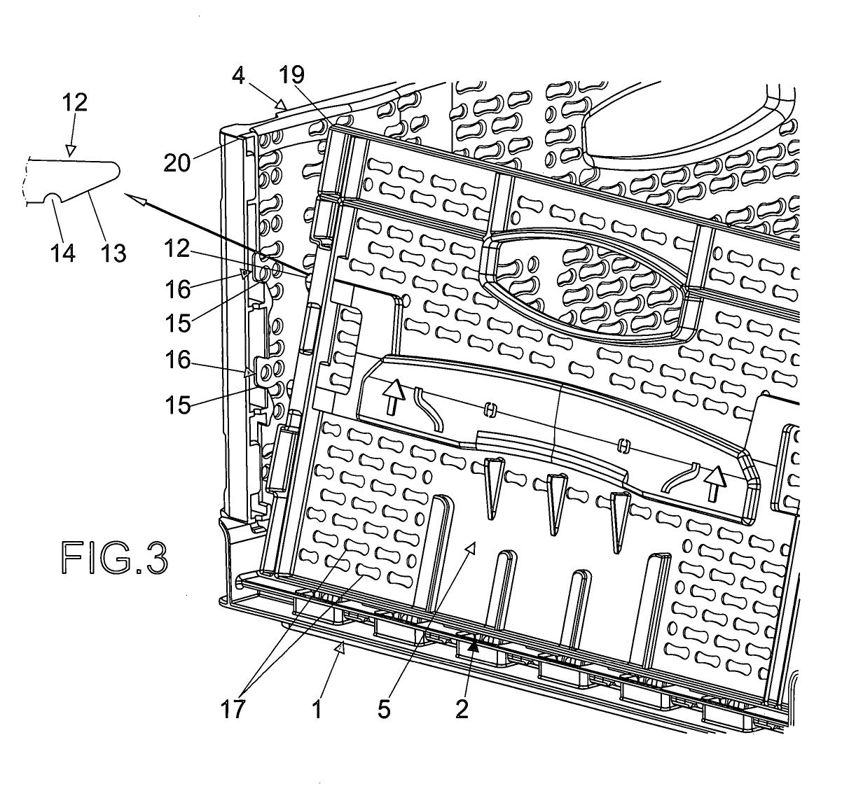

### DESCRIPTION OF THE PREFERRED EMBODIMENT

Considering the numbering used in the figures, the folding box is defined by a rectangular base 1, whose side edges include some female parts 2 that are complemented with some male parts 3 integral with the bottom edges of the side walls: larger ones or sides 4 and smaller ones or front ends 5.

The larger edges of the base 1 are located at an upper level with respect to the smaller edges. In this way, the total folding of the side walls 4 and 5 will be possible in two superposed planes parallel to the base 1: one bottom plane corresponding to the front ends 5 and a top plane corresponding to the sides 4.

The female elements 2 comprise a center recess 6, an end recess 7 and an end hole 8.

The male parts 3 comprise in turn a U-shaped center body 9, an end shaft 10 that is complemented with the hole 8 of the female part 2 and an end projection 11 that is complemented with the recess 7 of the female parts 2.

The assembly of the box is started with the coupling of the sides 4 which requires them to be positioned in a specific angle, for example 45° (although it could have been any other angle) with respect to the base 1. In this position, the shafts 10 of the male parts 3 will be opposite the holes 8 of the female parts 2, at the same time that the end projections 11 of the male parts 3 will sit on the end recesses 7 of the female parts 2.

In a subsequent step, the sides 4 move in the direction of the end shafts 10 until they are made to fit in the complementary holes 8 of the female parts 2, whereby, the center bodies 9 and end projections 11 are opposite the recesses 6 of the female parts 2. The sides 4 will now be located in a position in order to be able to be collapsed and placed in a folded or unfolded position without the projections 3 interfering in said collapsing.

Once the sides 4 are located in a totally unfolded position wherein they form a 90° angle with respect to the base 1, then the assembly of the front ends 5 is carried out by acting in principle in the same way as with the sides 4. This is in such a way that at the end of the collapsing towards the unfolded position of the front ends 5 a connecting and anchoring between the side walls 4 and 5 is produced since the side walls have their vertical edges adjacent to the anchoring parts.

These anchoring parts comprise some projections 12 integral with the front ends 5 that have some bottom ramps 13 that end in some recesses 14 where the edges 15 of some open notches 16 formed in the sides 4 are attached, in such a way that in said notches 16 the projections 12 of the sides 5 fit in the unfolded position in order to achieve the complete and solid assembly of the box.

This end connection or attachment of the front ends 5 on the sides 4 is carried out by elastic connection, in such a way that in order to proceed with the folding of the box, the folding will begin by collapsing the front ends 5 towards the inside of the box, by applying at the beginning a certain force upward in order to better release the connection between the projections 12 and the notches 16.

The bottom edges of the side walls (4, 5) have flat seats that are complemented with flat seats of the edges of the base 1. The male coupling parts 3 and female coupling parts 2 are located in these flat seats.

The side walls (4, 5) and base 1 include some circular ventilation holes and many other elongated holes 18 that have a particular shape of rounded ends and narrow middle sections limited by the opposite arched edges.

The side walls (4, 5) include some large handle-type openings 18.

Aside from the cited anchoring parts, there are some top gradations 19 on the sides of the front ends 5 that complementary come up against some top flaps 20 located in the ends of the sides 4.

1. Folding box, that comprises a structure that can be disassembled formed by a low parallelepiped base and four side walls (sides and front ends) that connect to the edges of the base by means of male parts integral to the side walls and female parts located in the edges of the base; these edges being located in pairs opposite the base at different heights; the side walls also connect each other by their adjacent edges by means of anchoring parts; characterized in that the male parts (3) comprise a central body (9), an end hinging shaft (10) and an end projection (11), whereas the female parts (2) comprise in turn a central recess (6), an end hole (8) where the hinging shaft (10) joints and fits in and an end recess (7) where the end projection (11) is located at the beginning of the coupling of the side walls (4, 5) which can only be positioned at a certain angle; all so that once the hinging shafts are opposite the end holes (8) in order to move the side walls (4, 5) for the definitive coupling thereof, where the center bodies (9) and end projections (11) are opposite the center recesses (6) of the female parts (2).

2. Folding box, according to claim 1, characterized in that the anchoring parts located in the pairs of adjacent edges of the side walls (4, 5) comprise projections (12) integral to one of the adjacent edges, these projections (12) having some recesses (14) where bottom edges (15) of a notch (16) of the other adjacent edge connect, the respective projections (12) inserting in such notches (16); all of this so that when the unfolding of the side walls finishes the projections (12) become attached, by means of the recesses (14) in the bottom edges (15) of the open notches (16).

3. Folding box, according to claim 2, characterized in that the projections (12) include a ramp or initial inclined plane (13) that ends in the attachment recess (14), all in order to facilitate the anchoring of the side walls in the end part of the assembly of the box.

4. Folding box, according to claim 2, characterized in that the sides of the adjacent edges of two of the sides walls (3) include top gradations (19) that are complemented by some complementary flaps (20) integral to two of the four side walls of the box.

5. Folding box, according to claim 1, characterized in that it includes rounded end ventilation holes (17), that have a central narrowing limited by two opposite arched sections.

6. Folding box, according to claim 2, characterized in that it includes rounded end ventilation holes (17), that have a central narrowing limited by two opposite arched sections.

7. Folding box, according to claim 3, characterized in that it includes rounded end ventilation holes (17), that have a central narrowing limited by two opposite arched sections.

8. Folding box, according to claim 4, characterized in that it includes rounded end ventilation holes (17), that have a central narrowing limited by two opposite arched sections.
